(19) United States
(12) Patent Application Publication
(10) Pub. No.: US 2008/0073282 A1
(43) Pub. Date: Mar. 27, 2008

(54) Device and Methods for Shearing Magnetic Floc in a Water Treatment System

(76) Inventor: Steven L. Cort, Cary, NC (US)

Correspondence Address: Coats & Bennett, PLLC/Michael deAngeli, 1400 Crescent Green, Suite 300, Cary, NC, 27581, US

(21) Appl. No.: 11/862,732

(22) Filed: Sep. 27, 2007

Related U.S. Application Data
(60) Provisional application No. 60/847,372, filed on Sep. 27, 2006.

(51) Int. Cl. B01D 37/03; B03C 1/30

(52) U.S. Cl. 210/695; 210/208; 210/768

(57) ABSTRACT

A horizontally-extending shear tank having a plurality of blades spaced along a horizontally extending elongated shaft disposed in the tank for shearing floc in a water treatment system. A method of collecting a swath magnetic floc, transferring the floc to the horizontally-extending shear tank, shearing magnetic seed from the floc to produce a slurry swath, and transferring the slurry swath to a magnetic device to separate the magnetic seed for recycling.

### CROSS-REFERENCE TO RELATED APPLICATION

This application claims priority under 35 U.S.C. § 119(e) from the following U.S. provisional application: application Ser. No. 60/847,372 filed on Sep. 27, 2006. That application is incorporated in its entirety by reference herein.

### FIELD OF THE INVENTION

The present invention relates to water treatment, particularly to the use of magnetic seeding and separation to clean water.

### BACKGROUND OF THE INVENTION

Briefly, “magnetic seeding and separation” technology as referred to herein involves adding a magnetic seed material to water that contains fine pollutant particles. The magnetic seed material is attached under agitation to the pollutant particles with an organic flocculating agent. The flocculated particles are now magnetic and are removed from the water with either permanent magnets or electromagnets.

A known commercial application of magnetic seeding is the “Sirofloc” technology used in Australia to clean drinking water. This process uses the absorption capacity of magnetite to remove color and other pollutants from water. The spent magnetic seed material magnetite settles out by gravity in a clarifier and then is pumped to a magnetite regeneration step that cleans the magnetite so it can be reused.

Another known commercial application of magnetic seeding is the “Comag” process described in Wechsler U.S. Pat. No. 6,099,738. This process has a high gradient magnetic field collector that uses powerful electromagnets. Once the collector becomes loaded with solids, it is backwashed with air and water to flush the magnetic seed material to a cleaning process. The cleaned magnetic seed material is then reused in the treatment process. The electromagnets in the Comag system have to be de-energized for cleaning. The cleaning process interrupts the flow of water for treatment and high solids loading limits the ability to backwash the system.

### SUMMARY OF THE INVENTION

The present invention also entails a method of treating water containing floc seeded with magnetic seeds. The method comprises feeding a first swath of floc into an inlet of a horizontally-extending shear tank and therein shearing the floc. Shearing the floc includes contacting the floc with a plurality of moving blades connected to an elongated shaft disposed horizontally in the horizontally-extending shear tank. Shearing the floc produces sheared slurry of magnetic seeds and sludge. The method also includes feeding a second swath of magnetic seeds and sludge from the horizontally-extending shear tank to a rotating magnetic collector to extract the magnetic seeds from the sludge. The magnetic seeds are fed to a flocculation tank, and the sludge is discharged.

### BRIEF DESCRIPTION OF THE DRAWINGS

FIG. 1 is a schematic plan view of an apparatus according to one aspect of the invention, with a magnetic separator device mounted in the upper portion of a flocculation tank.

FIG. 2 is a schematic end view of one embodiment of the magnetic separator device.

FIG. 3 is a more detailed schematic view of FIG. 2 showing a portion of a magnetic drum and scraper assembly used to first separate magnetic floc from the water stream and then to return cleaned magnetic seed to the floc tank for reuse.

FIG. 4 is a schematic side view of a tank and related equipment for carrying out the method of the invention.

FIGS. 5a, 5b and 5c, show details of scraper designs.

FIG. 6 is a perspective view of the horizontally-extending shear tank.

FIG. 7 is an end view of the horizontally-extending shear tank juxtaposed with a floc collector and a seed extractor.

FIG. 8 is a perspective view of the horizontally-extending shear tank juxtaposed with a floc collector and a seed extractor in a treatment tank.

### DETAILED DESCRIPTION OF THE INVENTION

The present invention is in the technical field of removing fine particles from water. The fine particles can include metal precipitates, organic solids, inorganic solids, clays, silts, oil and grease and any other hard to remove fine solids. The invention is applicable to industrial wastewater, municipal wastewater, potable water, combined sewer overflow, storm water, process water, cooling water, ground water, and any other waters that require clarification to remove fine particles. The term “water” as used herein includes water and all forms of wastewater.

The invention relates to the use of magnetic seeding and separation technology where a fine magnetic seed material is added to the water along with an organic flocculating polymer. The organic flocculating polymer binds the non-magnetic pollutant particles to the magnetic seed material and then the composite particle, or magnetic floc. In some embodiments, a flocculating polymer may not be used but rather the sorption properties of the magnetic particles are employed to extract pollutants from the water and attaché the pollutants to the magnetic particles. In some cases, certain scalants may be removed by employing magnetic particles whose surfaces provide sites for sacrificial scaling thus preventing or reducing scaling on downstream equipment. In any case, the invention includes utilizing the magnetic properties of the magnetic particles, bound with pollutants—be they in the form of flocs, particles with pollutants sorbed therewith, or scaled magnetic particles—to magnetically remove the pollutants from the water.

Collectors employing magnetized surfaces are used to attract magnetic particles and their burden of pollutants. The magnetized surfaces are generally moving magnetized surfaces to facilitate continuous transport of collected particles out of the water. The surfaces are equipped with permanent magnets or electromagnets to provide the required magnetic strength to remove the magnetic particles. The magnetic strength of the magnets used ranges approximately 0.1 to 10 tesla. Permanent magnets may be more commonly 0.5 to 1.5 tesla while electromagnets may be configured with a strength up to about 10 tesla.

The magnetically collected magnetic floc are further processed to form separate streams of sludge to be ejected as a waste product and cleaned magnetic seed to be recycled and reused in the water treatment system.

The process of using magnetic seeding and separation technology for removing fine pollutant particles sometimes involves attaching the fine pollutant particles to the magnetic seed material with a flocculating polymer. In a traditional flocculation process, the aim is to produce a large floc that will settle rapidly by gravity. To assure this floc formation, it is important to have the proper mixing energy. The measure of this mixing energy is referred to as the root-mean-square velocity gradient G measured in negative seconds (sec⁻¹). For optimum floc formation in a gravity separation situation, the G value should generally not exceed approximately 50 sec⁻¹. Exceeding this level increases the speed of mixing and the formation of microfloc, but will shear the floc and prevent the development of large macroflocs that will settle rapidly.

Magnetic seeding and separation is different. Since the size of floc is not important because gravity settling is not employed, the G value can be greatly increased because all that is needed is for the magnetic and non-magnetic particles to collide quickly in the presence of the flocculating polymer. Therefore the G value can be increased to about 100 sec⁻¹ and higher, which will speed the flocculation and therefore clarification process. The G value should generally be greater than about 50 sec⁻¹ and less than about 1000 sec⁻¹ but more preferably in the range of about 100 to about 500 sec⁻¹ in magnetic seeding and separation.

Various forms of magnetic seed material may be used. Among the forms is magnetite, a ferromagnetic form of ferric oxide. Other forms include but are not limited to zero valent iron, ferrosilicon, maghemite, jacobsite, trevorite, magnesioferrite, magnetic sulfides like pyrrohotite and greigite, and any other ferromagnetic and ferromagnetic materials that show strong attraction to a magnetic field.

Magnetic seed particle sizes in the range of 30 to 50 microns, as would be characteristic of 90% of material passing a 355 mesh, may be commonly used as magnetic seed for binding or sorbing pollutant particles for removal. Further, for various sorption processes, those that for example may be useful for removing very fine or nano pollutant particles, magnetic seed sizes may range down to approximately 20 nanometers. Magnetic seeding in treatment vessels such as flocculation tanks is typically done at a concentration by weight of magnetic seed of about 0.5 to 1% and which in some cases may up to about 3-5%.

### Tank Design

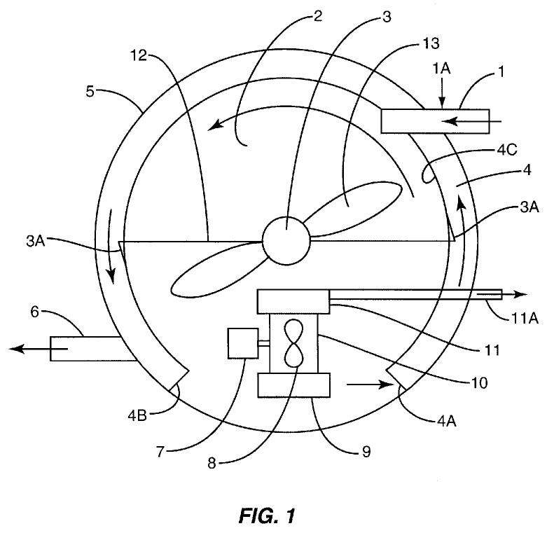

With reference to the drawings, a final magnetic collector 4 is configured to maximize the residence time in the flocculation chamber while maximizing the surface area of the final magnetic collector. One way to do this is to locate the floc chamber in the center and bottom of a cylindrical tank and then to extend the final collector around the perimeter of the upper regions of the tank, as illustrated in FIG. 1. In this way, the floc chamber occupies a maximum volume of the tank, increasing the residence time during which the flocculent effectively attaches fine pollutant particles to the magnetite, or magnetic seed to form composite particles or magnetic floc. This allows the use of magnetic techniques for removal of the fine pollutant particles from the water stream.

The tank can be a circular cylindrical tank with a circular final magnetic collector 4 extending around the perimeter of an upper portion of a treatment tank 5, as illustrated in FIG. 1. Disposing final magnetic collector 4 around the perimeter of tank maximizes the surface area of the collector, effectively slowing the motion of the composite particles to less than 18 inches per second and increasing their residence time in the collector. A speed faster than 18 inches per second will tend to dislodge the magnetic particles from magnetized surfaces of final magnetic collector 4.

Scaling up the tank design for high flow rate applications requires a larger final magnetic collector 4 which is most easily accommodated by placing it in proximity to the perimeter of the tank 5. The efficiency of final magnetic collector 4 is reported as the Surface Overflow Rate (SOR) which is measured in gallons per minute per square foot (gpm/ft²) of surface area. The SOR for a traditional gravity clarifier is 0.25 to 1.00 gpm/ft². The SOR for the present invention ranges from 10 gpm/ft² to 300 gpm/ft² which makes magnetic separation technology more effective than gravity clarification.

FIG. 1 shows a typical layout for positioning of key treatment elements. The important features include provision of a cylindrical tank 5 which is strong and easy to construct, whereby a large portion 2 of the tank volume is dedicated to the flocculation of pollutants to magnetic seed material, and provision of a long flow path for a final magnetic collector 4. In some applications, a square or rectangular tank may be utilized in the process since a final magnetic collector 4 can be configured such that it can be disposed along one side of the tank. See, for example, the description here below of a magnetic belt collector. While more expensive to construct, a square tank has some improved flocculation characteristics because of improved mixing in that it does not require baffles to increase turbulence as may sometimes be the case with circular tanks.

Referring in particular to FIG. 1, water flows into the tank through a pipe 1 where flocculating polymer 1A is added. The water flows into a central flocculation chamber 2 that contains magnetic seed particles (typically magnetite), so that composite magnetic particles, or magnetic floc, formed are made up of the pollutant particles bound by the flocculent to the magnetic seed. A flocculation mixer motor 3 and mixer blade 13 are provided to ensure thorough mixing. Water then flows through an opening 4A into an outer shell which contains a final magnetic collector 4 that extends about the perimeter of the tank 5. In this space any of a variety of different types of final magnetic collectors 4 can be installed. In one embodiment, the magnetic seed material or particles will be collected along an inner magnetized surface 4E closest to the flocculation chamber 2 and moved by a mechanical scrapers 3A disposed on ends of arms 12 driven by flocculation motor 3. Clarified water overflow out pipe 6 while scrapers 3A urge magnetically collected seeded floc along surface 4E and one to drum 9 of a magnetic seed cleaning system disposed in tank 5. A motor 7 drives two magnetic drum devices 9 and 11. The first magnetic drum 9 collects magnetic floc and directs the magnetic floc to a shear device or tank 10 that includes a shear mixer 8 that shears the magnetic particles away from the non-magnetic pollutant particles producing a slurry of magnetic seeds and sludge. These materials are separated magnetically on drum 11 with the magnetic seed material going back into the flocculation chamber for reuse and the non-magnetic pollutants, or sludge, being discharged for disposal 11A. The location of the first magnetic drum 9 can be advantageously placed in front of the opening 4A so that is removes magnetic particles before they reach the final magnetic collector 4 as well as receiving scraped floc from the final collector. This dual duty for the first magnetic drum or collector 9 reduces the solids loading on the final magnetic collector 4. The first magnetic collector 9 that removes the magnetic floc for seed separation and cleaning is typically shown as a magnetic drum but can be in other configurations.

### Horizontal Shear Device

A first magnetic drum collector is used to collect the composite magnetic particles, or magnetic floc, comprising the pollutants to be removed, the flocculant, and the magnetic seeds. The first magnetic drum collector or a second magnetic drum collector can be used clean the pollutant and flocculent from the magnetic seed material so the seeds can be reused. For example, a first magnetic drum rotating about a horizontal axis is submerged into the floc tank where the first magnetic drum collects the composite magnetic floc. Typically, the magnetic floc is scraped off the magnetic drum into a vertical shear tank where fine pollutant particles are detached from the magnetic seed by a vigorous mixing action. The clean magnetic seed is then collected on a second magnetic drum collector and scraped back into the floc tank.

Mounting the shear tank in a vertical position causes a surging in the tank, especially if the tank is square, when the magnetic floc is scraped into the tank. This surging action causes an uneven amount of magnetic seed to be deposited on the second magnetic drum collector. There are also some layout problems caused by use of a vertical shear tank; notably, if a relatively wide first magnetic drum collector is used for removing magnetic floc from the floc tank, it will not match up well to a much narrower vertical shear tank. A better configuration is to mount the shear tank in a horizontal position, parallel to the first magnetic drum collector, and to make the shear tank of similar width to the first and second magnetic drum collectors. Doing so also avoids the surging found in a vertically mounted shear tank.

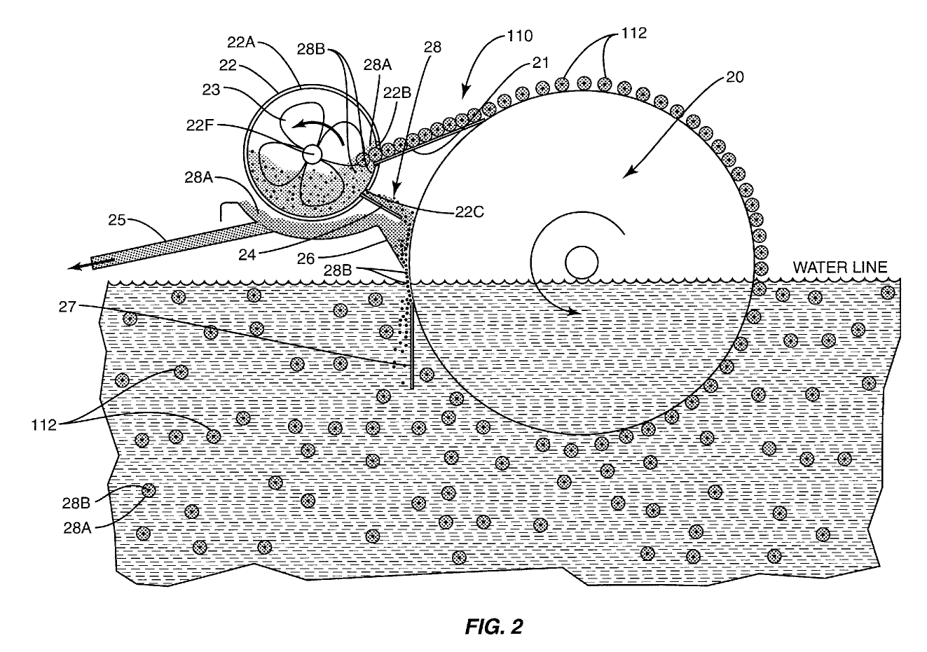

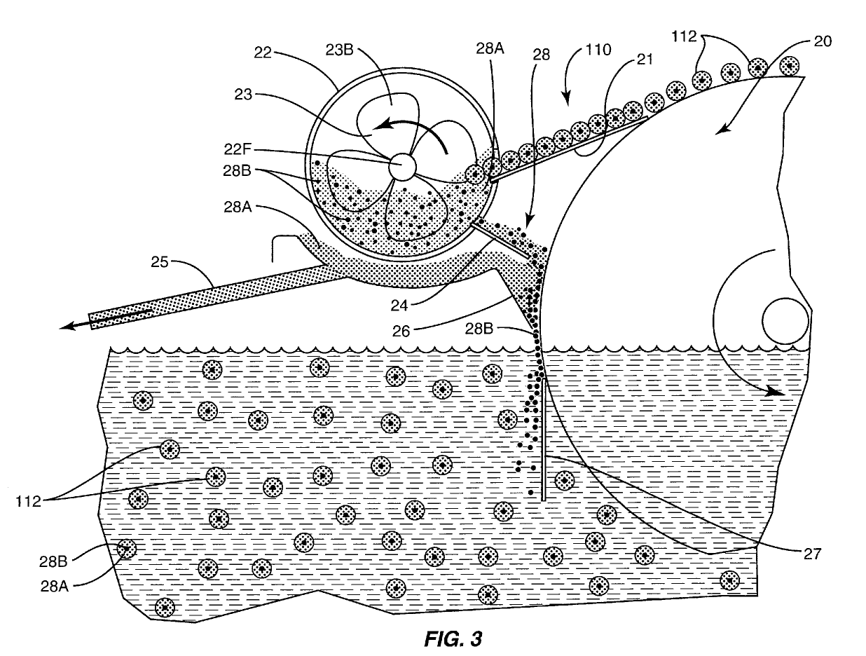

FIG. 2 shows a horizontal shear tank 22 juxtaposed to a rotating magnetic drum 20 which removes composite magnetic particles from the flocculation chamber for cleaning the pollutant particles and flocculant from the magnetic seed particles. The composite particles are scraped from the surface of drum 20 by a scraper 21 and flow down its upper surface into the horizontal shear tank 22. Inside this tank is a high-shear powerful mixer 23 that causes separation of the magnetic seed magnetite, for example from the pollutant particles. The sheared slurry flows out of the tank 22 through a slot onto a trough 24 and back onto the magnetic drum 20. The magnetic particles are attracted to the surface of the drum 20, while a scraper 26 pressing against the magnetic drum 20 causes the water that contains the pollutants to overflow into a discharge pipe 25 for disposal. See FIG. 3 for an enlarged view. The pressed magnetic seed is then scraped 27 off the magnetic drum so the magnetic seed can be returned to the floc chamber to be reused.

### Magnetic Drum Design

The goal is to use only one magnetic collector to remove magnetic floc from the floc tank and return cleaned magnetic seed into the floc tank. Magnetic floc collected on the magnetic collector are scraped off by a first removal device, or scraper, and transferred into a shearing device. The shearing device shears the magnetic floc to free the magnetic seed from the floc, producing a slurry of magnetic seeds, flocculant, and pollutants, the flocculant and pollutants essentially forming a sludge It is necessary to separate the magnetic seed from the sludge so the magnetic seed can go back into the floc tank for re-use, while the separated sludge is disposed. It was observed that a blade, or retainer, pressing against the magnetic drum will squeeze or compress the magnetic seed together, urging any remaining sludge away from the seed and leaving the seed substantially dry. The sludge will then overflow over the blade, or retainer, to be discharged, while the compressed and substantially dry magnetic seed will be removed by another scraper and returned to the floc tank for re-use. This approach employs the same magnetic collector to remove magnetic floc from the water and to separate the magnetic seed from the sludge after shearing. One magnetic drum is eliminated, which reduces cost, space requirements, and mechanical complexity of the system.

FIG. 3 shows an enlarged detail of FIG. 2, illustrating the manner in which magnetic seed is separated from non-magnetic pollutants. Sheared sludge, referred to sometimes as a sheared slurry of magnetic seeds a sludge, exits through a slot in the horizontal shear tank 22 which contains a shear mixer 23 and flows down a trough 24 back onto the surface of the same rotating magnetic drum 20 that first removed the dirty sludge from the flocculation tank. The magnetic material adheres to the drum and is collected in a wedge-shaped collection area formed by a retainer or trough 26 extending along the surface of the drum 20. The lower end of trough 26 is spaced close to the surface of drum 20, so that it squeezes out water that contains the non-magnetic pollutants while the separated magnetic seed material is attracted to and retained on the surface of the drum 20. The retainer 26 prevents the non-magnetic slurry from going back on the drum and into the flocculation chamber. Rather the slurry overflows the retainer 26 into a sludge collector comprising a discharge pipe 25 for disposal. The magnetic seeds that adhered to the magnetic drum 20 are scraped off its surface by a scraper 27, and drops back into the flocculation chamber for reuse.

### Magnetic Separation as a Batch Process

Previous magnetic separation systems involved continuous flow applications. Here magnetic separation technology is used to treat waste in batches. This will allow all of the treatment functions to be carried out in the same tank, using a single motor and mixing paddle assembly. This has self-evident advantages in terms of space, complexity, and cost.

The motor operates at various speeds, so that the mixer blade can be driven at a slow speed to ensure good mixing and flocculation of the pollutant particles with the magnetic seed material, and at high speed to shear the pollutant particles from the magnetic seed in the cleaning process. The tank assembly includes a controllable source of magnetic field mounted near its bottom, the bottom forming a collection surface. The magnetic field source is operable so that the magnetic field can be applied as necessary. The magnetic field can comprise one or more permanent magnets that are movable toward or away from the collection surface. Alternatively one or more electromagnets that can be powered or depowered correspondingly are mounted adjacent the collection surface.

The treatment process includes the following steps:
a. The tank is filled, the flocculant and magnetic seed particles are introduced, and the mixer driven slowly to flocculate the pollutant particles with the magnetic seed material. At this point the magnetic field is not being applied, so that the magnetic particles are not attracted to the lower collection surface.
b. After a few minutes, the mixer is either turned off, so that the composite particles quickly settle out by gravity, or the mixer is allowed to continue to mix slowly, and the magnetic field is applied. This will separate the composite particles from the treated water, so that they form a sludge collected at the bottom of the tank.
c. A side valve is opened to decant the clarified water out of the tank. This leaves the collected sludge and a small amount of water in the bottom of the tank.
d. The magnetic field is deactivated, releasing the composite magnetic particles from the collection surface, and the mixer is operated at high speed. This shears the pollutant particles from the magnetic seed material.
e. Then the mixer is operated at slow speed and the magnetic field is again applied. This causes the cleaned magnetic seed magnetite, for example to be held to the bottom of the tank while the waste sludge stays in solution. The bottom valve is then opened to drain out the waste sludge. After the sludge is drained, the valve is closed, the magnets disengaged, and the tank refilled. This method for batch treatment is simple and inexpensive and makes it feasible to use magnetic seeding for small flow applications.

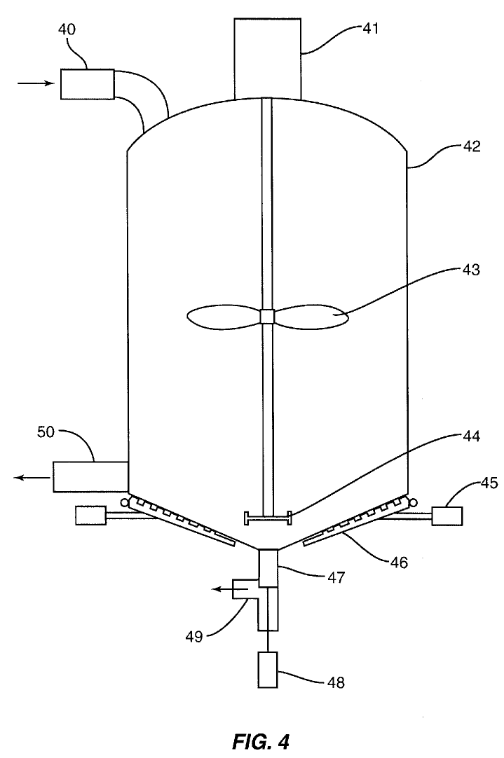

FIG. 4 shows one embodiment of a batch treatment system that uses magnetic seeding and separation technologies, as above. A tank 42 is provided with a mixer assembly, comprising motor 41, paddle or mixing blade 43, and shear blade 44. In this embodiment, the magnetic field is controlled by mounting permanent magnets 46 for controlled motion toward or away from the lower collection surface of the tank; the motion may be powered by air cylinders 45. First the tank 42 is charged with contaminated water through a pipe 40. Magnetite seed material, for example, may be present from prior processes, or may be added if necessary. Once the tank is filled, polymer (flocculent) is added to attach the pollutants to the magnetite. The mixer 41 is operated at slow speed to ensure good mixing while avoiding shearing of the floc as it forms. Once the water is clarified, the magnets 46 at the bottom of the tank are moved close to the collection surface to attract the magnetic particles in the tank. When all the magnetic particles are collected at the bottom of the tank, the clarified water is decanted through a pipe 50 in the side of the tank. Next, the magnets are moved away from the tank to release the magnetite and the mixer 41 is turned back on, now at high speed, as is necessary to shear the magnetic seed from the non-pollutant particles. Next the magnets 46 are moved against the surface of the tank to collect the magnetic seed and the mixer is turned off. A flush mounted valve 47 is opened, preferably with an operator 48 and the non-magnetic pollutants sludge are discharged through pipe 50. The process can now be repeated to treat another batch, that is, with the magnetic seed remaining in the tank during successive operations.

### Scraper Design

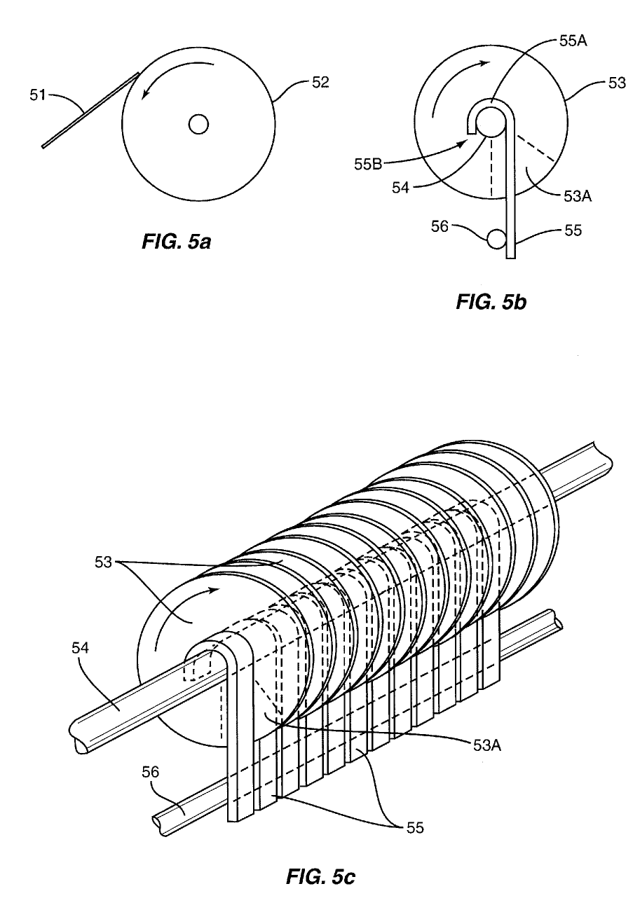

FIG. 5a shows a removal device or scraper 51 that includes a ferromagnetic material disposed such that the scraper is attracted to a magnetic drum 52 to remove collected magnetic floc from the drum. A magnetic attraction, or force, acts between drum 52 and scraper 51, and maintains a constant pressure between the drum and the scraper 51 over the entire length of the scraper, thus providing good scraping efficiency. This also provides a self adjusting feature to allow compensation for wear. The magnetic attraction, or force is independent of wear of the drum 52 or the scraper 51. Thus as either the drum 52 or the scraper 51 wears, the scraper is kept in contact with the drum with essentially the same force. Moreover, the magnetic force has an intensity that is generally constant over the area of contact or approach between the scraper 51 and the drum 52. This facilitates maintaining uniform contact over the area of contact or approach. This uniform contact is also therefore obtainable even in cases where the scraper 51 or drum 52 wears in a pattern that produces irregularities in the contact area. This design enhances the consistent and continuous cleaning of permanent magnet collectors. Scraper 55 is made of non-ferromagnetic material, preferably plastic which is easy to mold, inexpensive and abrasion resistant.

It should be noted, that scraper 51 also functions to convey removed magnetic floc from the magnetic drum 52. That is, since scraper 51 is magnetically held adjacent to or in contact with the magnetic drum 52, magnetic floc scraped from the drum 52 tends to move down the upper surface of scraper 51. Thus, scraper 51 not only removes the magnetic floc from magnetic drum 52, but also directs or channels the removed magnetic floc away from the magnetic drum. As discussed elsewhere herein, the removed magnetic floc is typically directed to a shear device where the magnetic floc is sheared producing magnetic seed and sludge.

FIGS. 5b and 5c show a removal device or scraper 55 that can be easily removed and which does not impede the flow of water between disks of a rotary magnetic collector that is disposed in a tank of water to collect magnetic floc. A plurality of scrapers 55 is preferably disposed between adjacent disks 53, so as to engage and scrape magnetic flocs from the opposed faces of the adjacent disks. Each scraper 55 has a hook end 55A by which it is suspended from a center shaft 54 holding the disks of the magnetic collector. An opening 55B formed by hook end 55A facilitates easy installation and removal of the scraper from above the magnetic collector for convenience. In one embodiment, the magnets are maintained stationary on disk (not shown) sandwiched between two plastic, or other non-magnetic material-based, rotating disks. Sometimes, magnets are omitted from a lower sector of the disks, forming a magnet-free sector 53A on each disk. This facilitates magnetic floc detaching at sector 53A of the disk surface where the scrapers 55 are be located. The scrapers 55 extend radially beyond the magnetic collection disks so that they can engage a stop or retaining bar 56 that prevents each scraper from moving out of the magnet-free sector 53A at the bottom of the magnetic collection disks. Alternatively, magnets may be embedded in a uniformly distributed array in a disk which rotates and from which magnetically-collected material is scraped. Scrapers 55 are hung from the center shaft 54 of the disk collector and mounted in a near vertical position so it does not impede the flow of water through the magnetic disk collector. In one embodiment, the general direction of flow is generally parallel to scrapers 55. Each space between disks includes one scraper, which can be arranged to scrape the opposed surfaces of adjacent disks.

### Alternate Embodiments of the Horizontal Shear Device

The present invention discloses water treatment system for treating water that includes seeded floc. The water treatment system comprises a horizontally disposed collector for collecting the seeded floc. A horizontally-extending shear tank is provided for receiving the seeded floc from the collector and shearing the seeded floc to produce a sheared slurry of seeds and sludge. The horizontally-extending shear tank includes a horizontally-extending tank, a horizontally disposed shearing device mounted in the horizontally extending tank, and an outlet formed in the horizontally extending tank for discharging the sheared slurry of seeds and sludge.

The invention also discloses a method of treating water that contains seeded floc. The method comprises collecting the seeded floc on a collector and removing the seeded floc from the collector. Further comprised in the method are the steps of directing the seeded floc into a horizontally-extending shear tank and shearing the seeded floc in the horizontally-extending shear tank to produce a sheared slurry of seeds and sludge. The method also includes the step of discharging the sheared slurry of seeds and sludge from the horizontally-extending shear tank.

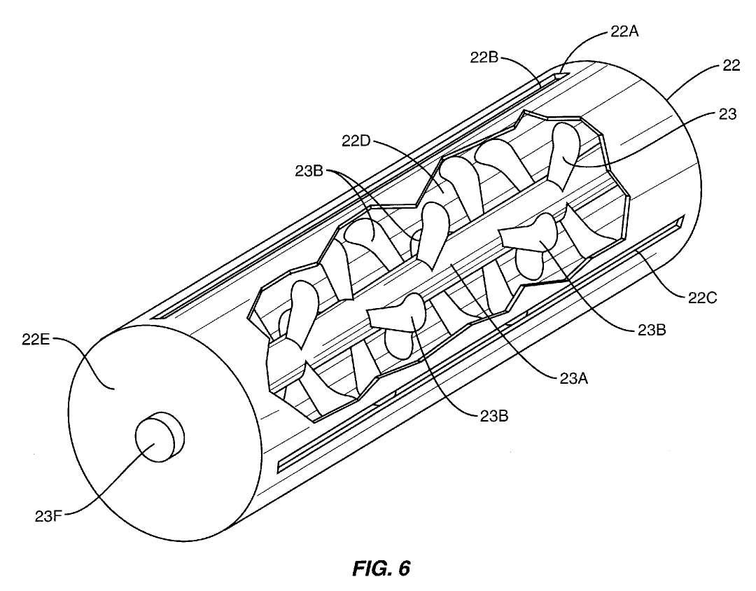

Turning now to a detailed description of the alternate embodiments, a horizontally-extending shear tank 22 may comprise the horizontal shear device as illustrated in FIG. 6. It is appreciated that horizontally-extending shear tank 22 is a generally elongated tank adapted to be disposed adjacent or at least partially within a treatment tank in a water treatment system. Horizontally-extending shear tank 22 is oriented such that a longitudinal axis of the tank is generally parallel with the surface of the water in the treatment tank. Thus disposing horizontally-extending shear tank 22 facilitates interfacing the tank with floc collection and seed extraction and recovery devices as will be described in more detail here below.

Turning now to a description of the structure of horizontally-extending shear tank 22, it is appreciated that in one embodiment the tank is a generally cylindrical hollow body. Disposed in an upper portion of tank side wall 22A is an inlet slot 22B extending longitudinally along a substantial portion of the tank side wall. An outlet slot 22C is spaced away from the inlet slot and similarly extends along a substantial portion of the tank wall. In one embodiment, inlet slot 22B is positioned at a level that is above the level of outlet slot 22C. Slots 22B and 22C enable access to the interior 22D of horizontally-extending shear tank 22 to permit the flow of materials into and out of the tank. Further, positioning inlet 22B at a level above outlet 22C tends to prevent backflow of material through the inlet. Other forms of backflow prevention devices may include one way valves and various kinds of baffles.

Rotatably mounted within horizontally-extending shear tank 22 is a mixer 23. Mixer 23 comprises an elongated shaft 22F and a plurality of blades 23B extending from the shaft and spaced apart along the shaft. Elongated shaft 22F may extend partially through an end wall 22E of horizontally-extending shear tank 22 to facilitate connection to a rotary drive source (not shown) for rotating the shaft about a central and longitudinal axis thereof relative to the tank. Each blade 23B extends from the shaft generally towards tank sidewall 22A, permitting a relatively small clearance, as compared to the inside diameter of the tank, between the blade and the side wall. It is appreciated that rotation of elongated shaft causes blades 23B to move within horizontally-extending shear tank 22.

In one embodiment, horizontally-extending shear tank 22 may be employed with a rotating magnetic drum 20 as illustrated in FIGS. 2 and 3 and discussed here before. As illustrated in FIG. 2, horizontally-extending shear tank 22 is disposed alongside a rotating magnetic drum 20 The drum 20 is partially submerged below the water line in a treatment tank containing flocculated water formed using magnetic seeds and a binder or flocculant. A swath 110 of floc 112 containing magnetic seeds 28B may be collected on an outer surface of rotating magnetic drum 20 as it rotates in the water. A swath is understood to be flow of material that is relatively wide and somewhat thin. Swath 110 of floc is scraped from drum 20 by floc scraper 21 and is directed along an upper surface of the scraper into horizontally-extending shear tank 22. Contact of swath 110 of floc with the plurality of blades 23B, moving due to rotation of elongated shaft 23A, shears the floc and produces sheared slurry of seeds 28B and sludge 28A. The sheared slurry flows out of horizontally-extending shear tank 22 and forms a swath 28 of seeds and sludge on first trough 24 as illustrated in FIG. 2. Swath 28 of seeds and sludge is deposited on the same rotating magnetic drum 20, received in a receiving area formed by scraper 26. Seeds 28B are magnetically attracted to drum 20, scraper 26 further compressing seeds 28B and sludge 28A such that most of the sludge overflows and is discharged via discharge pipe 25 and such that relatively dry seed remain on drum 20. A seed scraper 27 scrapes seed 28B off drum 20, and the seed are deposited into the treatment tank for re-use.

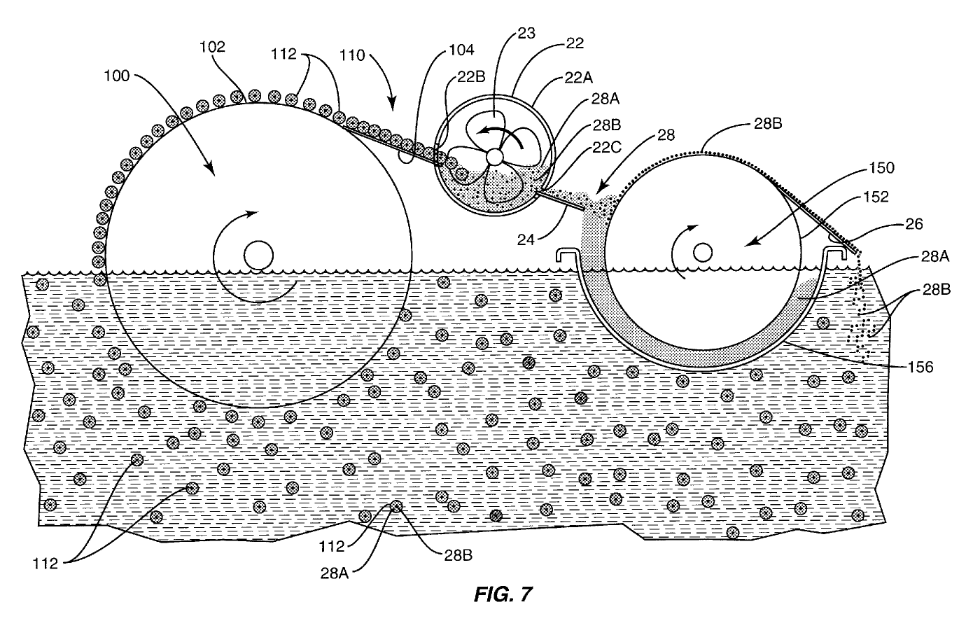

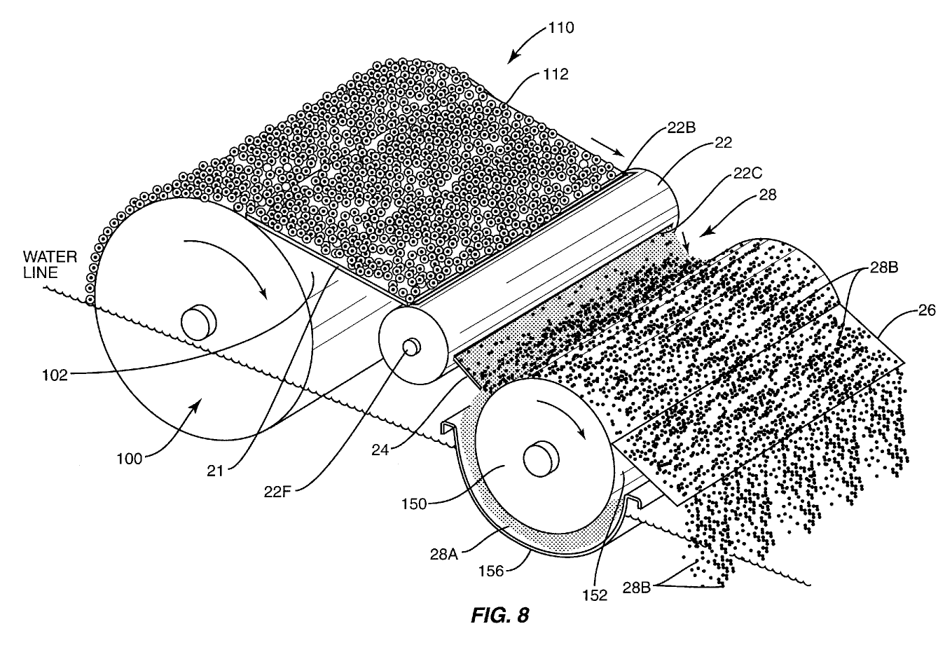

In another embodiment, horizontally-extending shear tank 22 may be used with a first and second rotating magnetic drums 100, 150 as illustrated in FIGS. 7 and 8. Horizontally-extending shear tank 22 is positioned between first rotating magnetic drum 100 and second rotating magnetic drum 150. First magnetic drum 100 includes a first rotating magnetic surface 102 and is disposed near the surface of the water in a treatment tank such that first surface 102 moves through the water. First magnetic drum 100 thus forms a collector for collecting floc 112 having magnetic seeds 28B. A first scraper 104 is disposed against the first magnetic surface 102 to scrape a swath 110 of floc 112 from the first rotating magnetic surface 102. Swath 110 of floc 112 is directed along the upper surface of scraper 104 and into inlet 22B of the horizontally-extending shear tank 22. Contact of the swath 110 of floc 112 with blades 23B causes shearing of the floc and forming of slurry of seeds 28B and sludge 28A. The slurry of seeds 28B and sludge 28A flows through outlet 22C of the horizontally-extending shear tank 22, on trough 24 forming a swath 28 of seeds 28B and sludge 28A that is directed a seed extractor or cleaner comprising a second rotating magnetic drum 150.

The second rotating magnetic drum 150 has a second rotating magnetic surface 152 that is isolated from the water. Rotating magnetic surface 152 forms a part of a seed extraction device to extract magnetic seeds 28B from sludge 28A and return the seeds to the treatment tank for re-use. Swath 28 of seeds and sludge is deposited against rotating magnetic surface 152 where the seeds are magnetically attracted to the surface and the sludge, being non-magnetic, falls away and is collected by sludge collection trough or surface 156. Seeds 28B are magnetically attracted to rotating magnetic surface 152. Scraper 26 scrapes seeds 28B off rotating magnetic surface 152 and into the treatment tank for re-use.

It is appreciated that horizontally-extending shear tank 22 is configured such that the length thereof, and in particular, the length of slot 22B disposed in wall 22A facilitates the efficacious movement of swath 110 of floc from a collection surface such as rotating magnetic surface 102 into horizontally-extending shear tank 22. Horizontal disposition of the tank 22 and the disposition of blades 23B spaced apart along elongated shaft 23A provide for effective and efficient shearing of flocs 112 to produce the sheared slurry of seeds 28B and sludge 28A. Further, the length and position of slot 22C facilitates the discharge of a swath 28 of seeds and sludge from tank 22, and the direction thereof to a seed extraction device such as the device including rotating magnetic surface 152 as described above.

The present invention may, of course, be carried out in other specific ways than those herein set forth without departing from the scope and characteristics of the invention. The present embodiments are therefore to be construed in all aspects as illustrative and not restrictive and all changes coming within the meaning and equivalency range of the appended claims are intended to be embraced therein.

1. A water treatment system for treating water including seeded floc, comprising:
a. a horizontally disposed collector for collecting the seeded floc;
b. a horizontally extending shear tank for receiving the seeded floc from the collector and shearing the seeded floc to produce a sheared slurry of seeds and sludge; and
c. the horizontally extending shear tank including:
i. a horizontally-extending tank;
ii. a horizontally disposed shearing device mounted in the horizontally extending tank; and
iii. an outlet formed in the horizontally extending tank for discharging the sheared slurry of seeds and sludge.

2. The water treatment system of claim 1 including a horizontal inlet disposed above the outlet in the horizontally-extending shear tank and wherein the inlet and the outlet each include a slot.

3. The water treatment system of claim 1 wherein the seeded floc include magnetic seeds and wherein the horizontally disposed collector is a horizontally disposed magnetic collector.

4. The water treatment system of claim 3 wherein the horizontally disposed magnetic collector comprises a rotary magnetic drum.

5. The water treatment system of claim 1 including a floc removal device to remove the seeded floc from the horizontally-disposed collector and direct the seeded floc to the horizontally-extending shear tank.

6. The water treatment system of claim 5 wherein the horizontally disposed collector comprises a rotary magnetic drum and the floc removal device comprises a scraper for scraping the seeded floc from the rotary magnetic drum, the scraper including a surface for receiving the seeded floc and directing the seeded floc to the horizontally-extending shear tank.

7. The wastewater treatment system of claim 1 wherein the horizontally-extending shear tank includes a first horizontal width and the horizontally disposed collector includes a second horizontal width, and wherein the first horizontal width is approximately equal to the second horizontal width to facilitate the seeded floc being directed from the horizontally disposed collector to the horizontal shear tank.

8. The water treatment system of claim 1 wherein the horizontally-extending shear tank includes an inlet for receiving the seeded floc and wherein the inlet is disposed at a level above the outlet.

9. The water treatment system of claim 8 wherein the inlet of the horizontally-extending shear tank comprises a slot.

10. The water treatment system of claim 1 including an elongated shaft that is horizontally disposed in the horizontally-extending shear tank and including a plurality of blades spaced axially along the elongated shaft, and wherein the elongated shaft is adapted to be driven to rotate about a longitudinal axis thereof.

11. The water treatment system of claim 1 including a floc collector for collecting the seeded floc and for directing the seeded floc to the horizontally extending shear tank, and a seed extractor for receiving a sheared slurry of seeds and sludge from the horizontally-extending shear tank and extracting the seeds from the sludge.

12. The water treatment system of claim 11 wherein the seeded floc comprise magnetic seeds and the floc collector includes a rotary magnetic drum.

13. The water treatment system of claim 11 wherein the seeded floc include magnetic seeds and the seed extractor includes a rotary magnetic drum.

14. A method of treating water containing seeded floc, comprising:
a. collecting the seeded floc on a collector;
b. removing the seeded floc from the collector;
c. directing the seeded floc into a horizontally-extending shear tank;
d. shearing the seeded floc in the horizontally-extending shear tank to produce a sheared slurry of seeds and sludge; and
e. discharging the sheared slurry of seeds and sludge from the horizontally-extending shear tank.

15. The method of claim 14 wherein the seeded floc include magnetic seed and wherein the collector includes a magnetic surface and the method includes contacting the magnetic surface with the water and attracting the magnetic seeds to the magnetic surface.

16. The method of claim 14 wherein collecting the seeded flocs includes magnetic seeds within the flocs and attracting the magnetic seeds to a rotating magnetic collector in contact with the water.

17. The method of claim 15 wherein the magnetic seeds include magnetite or other ferromagnetic material.

18. The method of claim 15 wherein removing the seeded floc from the magnetic surface includes scraping the seeded floc from the magnetic surface.

19. The method of claim 14 wherein directing the seeded floc into a horizontally-extending shear tank includes flowing the seeded floc along a surface of a scraper.

20. The method of claim 14 wherein shearing the seeded floc includes contacting the seeded floc with a plurality of blades connected to a horizontally disposed elongated shaft in the horizontally-extending shear tank and shearing the seeds from the floc to produce a sheared slurry of seeds and sludge.

21. The method of claim 14 including discharging the sheared slurry of seeds and sludge through a slot in the tank.

22. The method of claim 14 including directing the seeded flocs to an inlet of the horizontally-extending shear tank wherein the inlet is disposed at a level above the outlet of the horizontally-extending shear tank.

23. The method of claim 14 including discharging the sheared slurry of seeds and sludge through the outlet of the horizontally-extending shear tank wherein the outlet is disposed at a level below an inlet of the horizontally-extending shear tank.

24. A method of treating water containing floc seeded with magnetic seeds, comprising:
a. feeding a first swath of floc into an inlet of a horizontally-extending shear tank;
b. shearing the floc in the horizontally-extending shear tank by contacting the floc with a plurality of moving blades connected to an elongated shaft disposed horizontally in the horizontally-extending shear tank, producing a sheared slurry of magnetic seeds and sludge;
c. feeding a second swath of magnetic seeds and sludge from the horizontally-extending shear tank to a rotating magnetic collector to extract the magnetic seeds from the sludge; and
d. feeding the magnetic seeds to a flocculation tank and discharging the sludge.

25. The method of claim 24 wherein feeding the swath of floc includes collecting the floc on a rotating magnetic surface in contact with the water and scraping the floc from the rotating magnetic surface onto a surface of a scraper.
